(19) United States
(12) Patent Application Publication
(10) Pub. No.: US 2018/0276770 A1
(43) Pub. Date: Sep. 27, 2018

(54) RESTAURANT TABLE MANAGEMENT SYSTEM

(71) Applicant: PANASONIC INTELLECTUAL PROPERTY MANAGEMENT CO., LTD., Osaka (JP)

(72) Inventors: John CRONIN, Bonita Springs, FL (US); Jonathan T. GOGUEN, Brookline, NH (US); Jeff PADGETT, Burlington, VT (US); Masayuki IINO, Arlington, VA (US)

(21) Appl. No.: 15/467,805

(22) Filed: Mar. 23, 2017

(51) Int. Cl. G06Q 50/12; G06Q 30/06; G06Q 10/10; H04N 7/18; G06K 9/62; H04N 5/907; G06K 9/00

(52) U.S. Cl. CPC G06Q 50/12; G06Q 30/0635; G06Q 10/1095; G06K 9/00771; G06K 9/6202; H04N 5/907; H04N 7/183

(57) ABSTRACT

A restaurant table management system including: a processing subsystem having a processor, a memory, an input device and an input/output device; an imaging device for recording activity of a patron and contents on a table; a theme park database storing information regarding past orders and future activities associated with patrons frequenting the restaurant, each of the patrons having a specific identification code for identifying a given patron; and a user device which receives and transmits information to the processing subsystem. The user device inputs the identification code associated with a given patron and transmits the identification code to the processing subsystem, and the processor retrieves the information stored in the theme park database associated with the identification code of the given patron, and predicts service needs of the patron based on the activity of patron and data contained in the theme park database associated with the given patron.

### TECHNICAL FIELD

The present subject matter relates to a system and method for monitoring restaurant table activity to provide recommendations, alerts and predictions to restaurant staff members so that the staff members can efficiently address the needs of the patrons, for example in resorts, amusement parks, or other various types of restaurants.

### BACKGROUND

In most restaurants there is often significant amounts of wasted time during the dining experience. For example, after being seated by a hostess, the patrons may wait an extended period before a waiter arrives, as the hostess may not immediately inform the waiter the new patrons have been seated. As another example, once the food has been prepared, the waiter may not immediately realize the food is ready to be delivered to the table, which can result in a delay in delivering the food to the table as well as the food becoming cold. Further, as patrons finish their drinks, a significant amount of time often passes until the waiter realizes this, and inquires if the patron would like another drink. As another example, patrons are often still enjoying a first course, when the second course is prematurely delivered to the table. Alternatively, patrons can also wait an unnecessarily long time between courses. One of the most frequent issues is that upon completion of a meal, patrons must often wait a significant amount of time to receive the bill from the waiter, as the waiter has moved on to handling newly seated patrons, who require more time from the waiter in the beginning of the dining experience. Thus, the typical restaurant experience has a significant amount of time management issues associated with the interaction between the patrons and restaurant staff members, that can lead to an unpleasant dining experience for the patron. In addition, these time management issues can also reduce the overall number of customers that the restaurant can serve during a given time period, which results in lost revenue and profit.

A need therefore exists for system and method for reducing and/or eliminating the periods of wasted time during the dining process so as to make the dining experience more efficient and pleasant for the patron.

### SUMMARY

The present disclosure relates to a Restaurant Table Management System which monitors restaurant tables, for example, in a theme park restaurant, for the use, position, activity, etc. of patrons and table items (e.g., utensils, glassware, condiments, eating, talking, etc). The system provides immediate notification of patron needs and utilizing a correlation engine and artificial intelligence (AI) generates correlations between items and/or activities at the table and a theme park database to predict behavior at the table (i.e., length of stay, condiment use, order size, order type, etc.). These notifications and predictions are used to provide recommended actions by staff (e.g., collect dishes, provide drinks, add staff, etc.) or automatic responses by IoT devices (i.e., make more ice, adjust light/environment, etc.).

The Restaurant Table Management System of the present disclosure, among other things, allows restaurant staff to promptly respond to patron needs and/or preempt patron needs to: 1) improve the patron's dining experience; 2) improve supply chain and response; and 3) improve patron turnover. These actions improve the guest experience, quality of the restaurant and assist increasing revenue.

In accordance with one aspect of the disclosure, a restaurant table management system for use in a restaurant is provided, and the restaurant table management system includes: a processing subsystem including a processor, a memory, an input device and an input/output device, each of which communicates with the other; an imaging device for recording activity of a patron and contents on a table within the restaurant, the imaging device communicates with the input device of the processing subsystem; a theme park database storing information regarding past orders and future activities associated with patrons frequenting the restaurant, each of the patrons having a specific identification code for identifying a given patron, and a user device which receives and transmits information to the processing subsystem. The user device inputs the identification code associated with a given patron and transmits the identification code to the processing subsystem, and the processor retrieves the information stored in the theme park database associated with the identification code of the given patron, and predicts service needs of the patron based on the activity of patron and data contained in the theme park database associated with the given patron.

In accordance with another aspect of the disclosure, a method for providing restaurant table management for use in a restaurant is provided. The method includes monitoring activity of a patron and contents on a table within the restaurant, and recording images of the activity and storing the images in a memory device, each of the stored images being associated with a given patron, with each patron having a specific identification code for identifying the patron; generating a theme park database for storing information regarding past orders and future activities associated with patrons frequenting the restaurant, the information for each of the patrons being stored utilizing the identification code associated with a given patron; correlating data regarding the stored images of a given patron's activity and the information stored in the theme park database associated with the given patron; predicting the service needs of the given patron based on the correlated data regarding the activity of patron and data contained in the theme park database associated with the given patron, and outputting at least one of a recommendation, a notification and an alert to a user device based on the predicted service needs of the given patron.

Additional advantages and novel features associated to the restaurant table management system are set forth in the description which follows, and will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exemplary simplified functional block diagram of a processing platform that may be configured to implement the restaurant table management system of the present disclosure.

FIGS. 2A and 2B are exemplary high level flow diagrams illustrating the operation of the restaurant table management system.

FIG. 3 illustrates an exemplary theme park database utilized to assist in making recommendations for patrons.

FIGS. 4A and 4B illustrate the monitoring of the patrons utilizing a TOF or 3D cameras.

FIGS. 5 and 6 provide functional block diagram illustrations of general purpose computer hardware platforms.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to a restaurant table management system. The restaurant table management system monitors restaurant tables, for example, in a theme park restaurant, for the use, position, activity, etc. of patrons and table items so as to provide notification of patron needs utilizing a correlation engine and artificial intelligence (AI) generates correlations between items and/or activities at the table and a theme park database to predict behavior at the table. These notifications and predictions are then utilized to provide recommended actions by staff or automatic responses by IoT devices.

Reference now is made in detail to the examples illustrated in the accompanying drawings and discussed below.

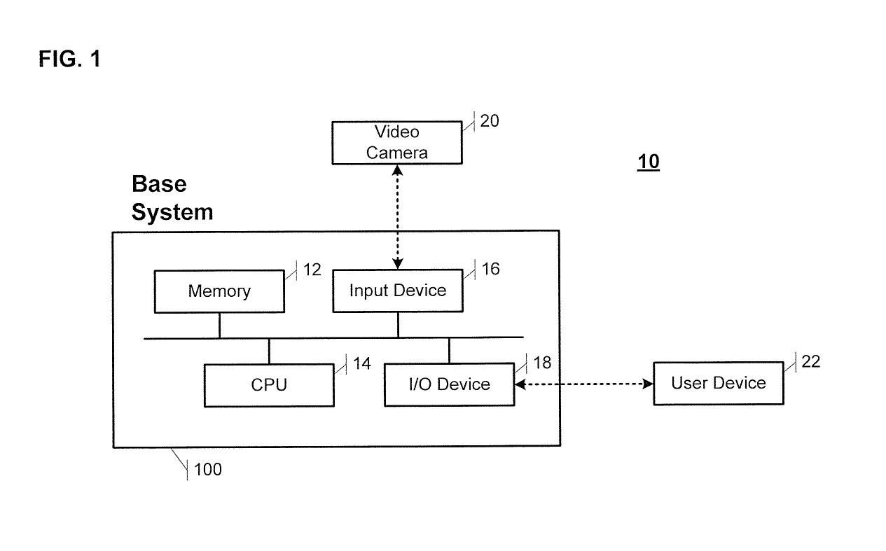

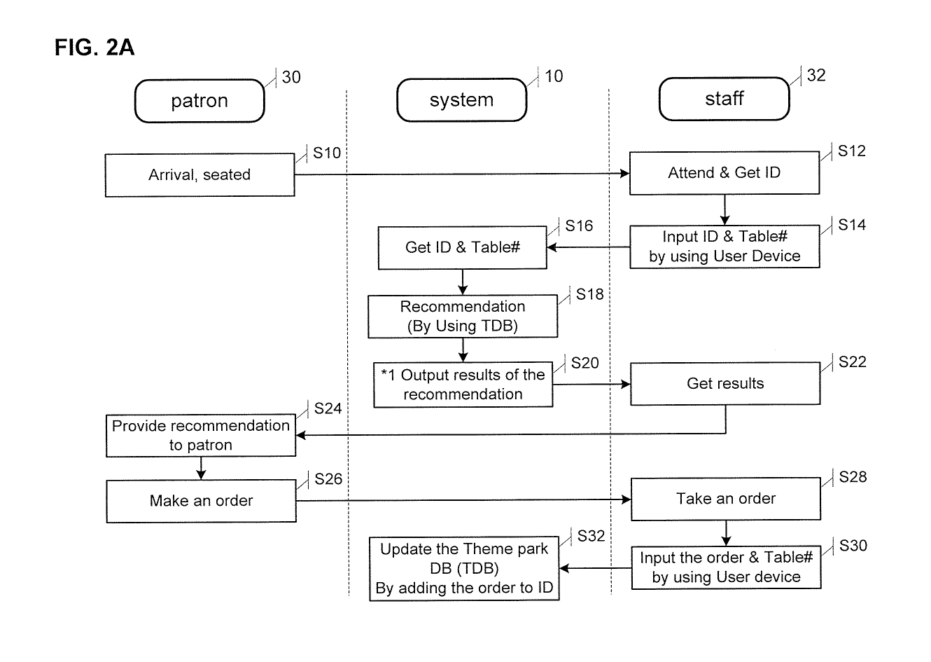

FIG. 1 is an exemplary simplified functional block diagram of a processing platform that may be configured to implement the restaurant table management system 10 of the present disclosure. As shown, restaurant table management system 10 includes a base system 100, which includes a memory 12, a CPU 14, an input device 16 and an input/output (I/O) device 18, and a video camera 20 and a user device 22. The details of the operation and functionality of these components will be explained in conjunction with FIG. 2 which is block diagram illustrating the operation of the restaurant table management system.

The central processing unit (CPU) 14 may be in the form of one or more processors, for executing program instructions, and may be implemented in a distributed fashion on a number of similar platforms, to distribute the processing load. Memory 12 can include one or more memories such as a ROM, a RAM, an EEPROM, a hard disk drive and/or a solid state memory. The memories may be a built-in type memory or a removable memory. The base system 100 includes a management control program (software), which is executable by the CPU 14, and when executed, controls operations of the base system 100. The software may further include network tracking software, network schedule software, network alert software and/or communication controls software. As explained further below, the memory 12 also includes various databases including, but not limited to, a theme park database.

The user device 22 may include, but is not limited to, a handheld mobile device, such as a cell phone, a smart phone, a PDA, a tablet computer or a laptop computer. The user device may include a computer/CPU, a GUI, storage and a communication circuit. The user device 22 provides data to the base system 100 and receives data from the system via I/O device 18.

The video camera 20 allows for video monitoring of the tables within the restaurant, and in the preferred embodiment allows for 3D monitoring using, for example, but not limited to, either a time of flight (TOF) camera or a 3D camera. The video camera 20 provides data to the base system 100 via the input device 16, which operates to receive the data from the video camera 20 and provide the data to the CPU 14 for processing. Multiple video cameras 20 can be utilized as is necessary to view each of the eating areas (i.e., tables) within the restaurant. It is noted that input device 16 and I/O device 18 may be implemented as separate elements as shown in FIG. 1, or alternatively, may be implemented in a single I/O device.

The components of the restaurant table management system 10 are communicatively interconnected by a communication network and/or by peer-to-peer or other communication links between components of the system 10. In one example, components of the base system 100 communicate with one another via an internal bus, and the base system 100 communicates with the video camera 20 and the user device 22 via a wireless network, such as a Wi-Fi based wireless communication network, a mobile wireless network, or the like, providing wireless communication services throughout the facility/restaurant. One or more communication antennas (not shown), which may include wireless access points, routers, and/or network repeaters, are provided to provide wireless communication coverage throughout the restaurant. The communication antennas can be communicatively connected to each other and to the base system 100, the video camera 20 and user device 22 through wired links such as Ethernet links.

FIGS. 2A and 2B are exemplary high level flow diagrams illustrating the operation of the restaurant table management system 10. Referring to FIGS. 2A and 2B, the operation of system is illustrated by separating the functions performed by the various entities of the system, namely, the patron 30, the restaurant table management system 10 and the staff 32 (e.g., waiter). It is noted that in the preferred embodiment, the staff 32 inputs and receives information via the user device 22. However, as one alternative it is also possible for the staff 32 to input and receive information from the base system 100 via the I/O device 18.

First, with regard to FIG. 2A which is an exemplary flowchart illustrating the operation of the system when the patron 32 first enters the restaurant and places an order, in step (S10), the patron 30 arrives at the restaurant and is seated at a given table. Upon being seated, the staff 32 meets the patron 30 and obtains an identification (ID) number (S12) associated with the given patron 30. The ID number can be assigned to the patron, for example, but not limited to, when the patron makes a reservation for the given restaurant, or when the patron is purchasing tickets for entry into the theme park. The ID number can be provided to the patron 30, for example, but not limited to, via text or email to the patron's smart phone or tablet, or can be printed as a barcode on a bracelet provided to the patron for entry into the theme park.

Upon obtaining the patron's ID, the staff 32 enters the patron's ID and table number (S14) at which the patron is seated utilizing the user device 22. It is noted that the ID can be manually entered by the staff 32 or can be scanned in utilizing a scanner on the user device 22. Alternatively, RFID technology can be utilized to input the patron ID, if for example, an RFID tag is disposed in the bracelet provided to the patron upon purchasing admission into the theme park. It is noted that each of the tables within the restaurant is also provided a number so as to allow for easy recognition of where the given patron is seated in the restaurant. Once the patron ID and the table number are input into the user device 22, the user device automatically transfers this information to the base system 100 (S16).

Upon receiving the patron ID, the base system 100 updates the theme park database and generates a recommendation regarding what the patron may wish to order based on the data of the patron and the data in the theme park database (S18). For example, based on the patron's age, sex, the patron's activities within the theme park, both past and future schedule events/activities, all of which are stored in the theme park database for the given patron, the CPU 14 using known artificial intelligence/machine learning related programs, such as but not limited to, SVM, Deep Learning, Bayesian Networking, etc.) generates a model which predicts what the patron may wish to order. As one example, the CPU 14 may be configured to implement a support vector machine (also known as support vector networks), which is a supervised learning model with associated learning algorithms that analyze data used for classification and regression analysis. Over time, by analyzing past orders of patrons having similar parameters (e.g., age, sex, ride/attraction history, food history, future scheduled events), the SVM model can predict what a given patron is likely to order. Of course, it is also possible to maintain records of a specific patron in the theme park database, such that if the given patron returns to the restaurant, the patron's own past order information can be utilized in the prediction process.

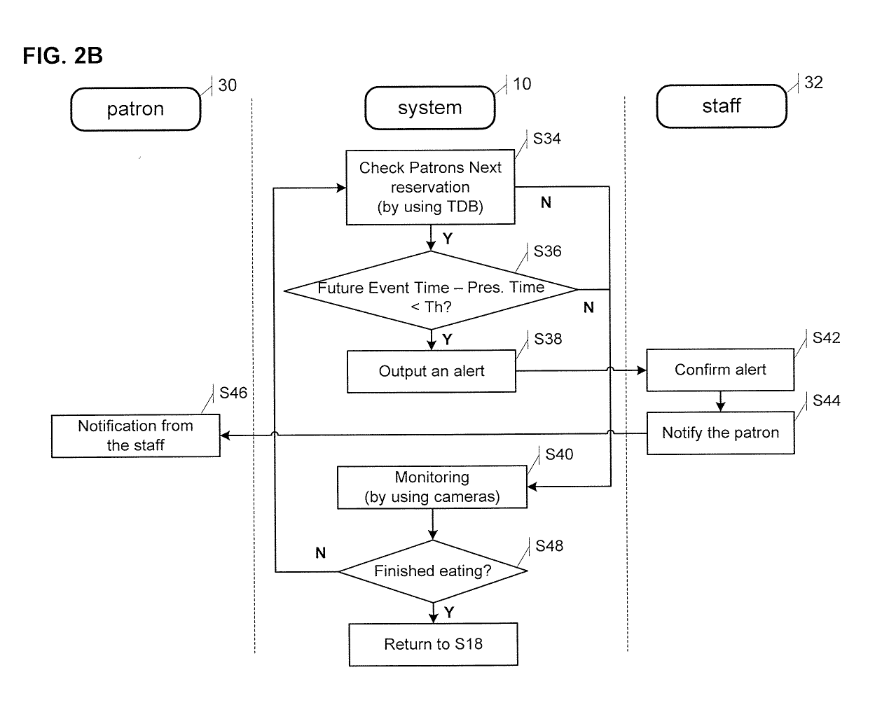

FIG. 3 illustrates an exemplary theme park database utilized to assist in making recommendations for patrons. As shown, the database includes for each patron information regarding, a patron ID, the sex of the patron (i.e., male/female), the patron's age, the attraction history (i.e., what activities/rides the patron has done prior to visiting the restaurant, the patron's food history (i.e., the food the patron has purchased prior to visiting the restaurant or in previous visits to the given restaurant) and future scheduled events for the given patron. The entries regarding attraction history and the food history of the patron can be obtained, for example, by reading an RFID provided to the patron upon entry into the park each time the patron rides or participates in a given attraction or frequents a food vendor, and then transmitting such data to the base system 100 for entry into the theme park database. It is noted that the foregoing categories for entry in the theme park database are intended to be only examples, as additional categories that may improve the prediction process may be added. For example, but not limited to, time and date of previous order, nationality, height and weight, and religious background of each patron may also be stored in the theme park database and utilized in the prediction process.

Once the recommendation process is completed, the CPU 14 outputs the recommendation results (S20) by means of the I/O device 18, and the recommendation results are transferred to the user device 22 so that they may be read and/or viewed by the staff 32 on the user device (S22). The staff 32 then provides the recommendation to the patron 30 either verbally or automatically via, for example, a tablet or a suitable terminal device provided at the given table, or the recommendation can also be sent to the patron's smart phone or tablet (S24). Upon receiving the recommendation, the patron 30 proceeds to place an order (S26) by communicating the order to the staff 32 (S28), and the staff inputs the order for the patron along with the patron's ID and table number using the user device 22 (S30). The order is then communicated to the base system 100 and the patron's record in the theme park database, which is identified by the patron ID, is updated to reflect the order (S32). Upon entry of the order by the staff, the order may also be directly forwarded to the kitchen. It is noted that in the given embodiment, upon the staff 32 entering the table number and patron ID utilizing his/her user device 22, that table and patron are tied to the user device of the staff 32 entering the data such that the future communications regarding recommendations for the given patron at the given table are forwarded to the user device 22 of the staff 32 that entered the data.

Turning to FIG. 2B, which is an exemplary flowchart illustrating the operation of the system after the patron has placed his/her order, in S34 the system accesses the theme park database to determine if the given patron (using the patron's ID) has any future events scheduled. As shown in FIG. 3, one of the items contained in the theme park database is the “Next Reservation,” which indicates upcoming events/reservation previously made by the patron. Such information can be input into the system 10 and the theme park database updated upon the patron, for example, purchasing tickets for an event, scheduling a reservation, or by the patron updating his itinerary to indicate events he would like to attend with a theme park staff member, who would then forward the information to the system 10 via a suitable communication means.

If the given patron does not have any future events currently scheduled, the system proceeds to S40 during which the activity at the table of the patron is monitored utilizing the video camera 20. The monitoring and associated processes are discussed further below. In the event the theme park database indicates that the given patron does have a future event planned, the system proceeds to S36 to determine how much time remains until the next event. If the time remaining between a future event (e.g., a parade on the theme park grounds) and the current time is less than a predetermined threshold amount, the base system 100 generates an alert (S38) which is forwarded to the user device 22 via the I/O device 18 so that the staff 32 is made aware of the upcoming event that the given patron wishes to attend (S42). The staff 32 then either verbally notifies the patron 30 of the upcoming event or automatically notifies the patron via, for example, a tablet or a suitable terminal device provided at the given table, or the notification can also be sent to the patron's smart phone or tablet (S44). Once the notice is provided to the patron (S46), the patron can decide to conclude the meal quickly so as to be able to make it to the event in a timely manner, or attempt to reschedule or simply miss the event. However, importantly, the system 10 provides an automatic reminder of an upcoming event, so that the patron can decide how best to proceed.

It is noted that the predetermined threshold amount can be set in accordance with the location and/or type of event in conjunction with the location of the restaurant within the theme park. For example, if the given restaurant is located directly adjacent an amphitheater in which a show the patron wishes to attend, then the threshold may be smaller, as compared to the situation where the amphitheater is located a 20 minute walk away from the restaurant. In each situation, the predetermined threshold amount should, at a minimum, provide the patron with amply time to request and pay for the meal and then travel to the location of the future event.

Continuing, and returning to S36, if it is determined that time remaining until the next event scheduled for the patron is greater than the predetermined threshold amount, the system proceeds to S40 during which the patron(s) at the given table are monitored utilizing the video camera 20 to determine if the patrons are finished eating (S48). If the patrons are not finished eating the system returns back to S34 and the foregoing steps are performed again. If it is determined that the patrons are finished eating, then the process proceeds back to S18 and the foregoing process repeats again starting at S18. It is noted that in returning to S18, the system once again makes a recommendation regarding a future order for the patron. For example, the initial order of the patron may have been a main entrée. By storing this previous order in the theme park database along with the time of the order, the CPU 14 utilizing one of the various available machine learning programs, can discern that the patron is now likely to consider dessert items and then recommend possible dessert items. In the event dessert items have already been recommended and ordered for a given patron and the theme park database updated for the given patron, upon return to S18, the system will determine there are no additional recommendations to make at this time, and notify the staff that it is time to provide the bill to the patron as the meal is likely over.

With regard to the video monitoring performed in step S40, in this step the video camera is utilized to monitor the activity at the table so as to determine whether or not the patron has completed a meal. The following presents two different methods of how the monitoring may be performed, however, any suitable method may be utilized. The first method is to monitor the movement occurring at the table, and when the movement is below a given threshold, the system concludes that the given meal is completed, and then sends the appropriate notification to the staff. Calculating the movement within a video is well known in the art, such as in MPEG processing, and as one example, it is possible to determine the movement by subtracting the present image from a previous image. Once the amount of change in movement is less than the predetermined threshold, and remains below the threshold for a set period of time (e.g., one minute), the CPU concludes that the given meal is completed and outputs a notification. It is noted that the appropriate threshold of movement to indicate when the meal is finished can obtained over time by analyzing previous dining actions and utilizing machine learning to continually update the threshold to be utilized. It is further noted that the number of video cameras required depends on the type of video camera being utilized and the number of tables within the restaurant.

Another method of monitoring that can be utilized is 3D monitoring utilizing Time of Flight (TOF) cameras or 3D cameras. In this method, the TOF or 3D camera is utilized to monitor the distance between the camera and the table, and specifically, the amount of food or drink on the table. For example, the distance between the TOF or 3D camera and an empty plate can be predetermined, and then when the meal is brought to the table, the cameras can measure the distance between the plate with the food placed thereon, which will be closer to the camera than an empty plate, and once the distance between the camera and the plate increases to distance which is approximate the distance to the empty plate, within some predetermined tolerance, the CPU concludes that the meal is completed, and outputs the appropriate notice. It is noted that the foregoing monitoring can also be utilized to determine drink levels, and send an appropriate notice once a drink has been completed so as to signal the staff to inquire if the patron would like another drink.

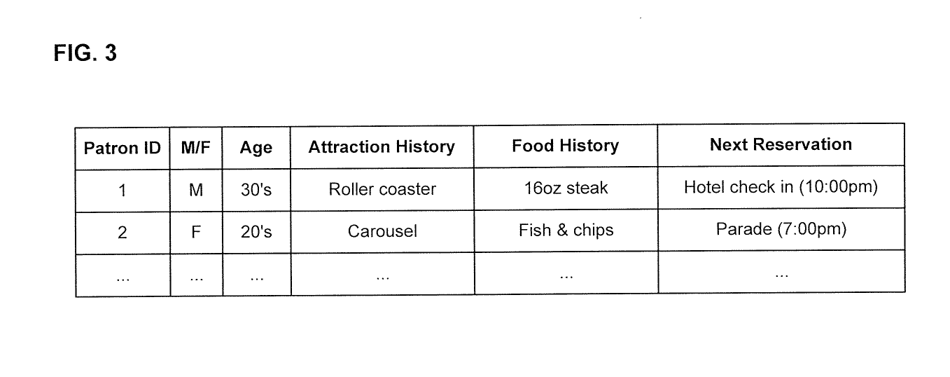

FIGS. 4A and 4B illustrate in more detail how the monitoring step can be performed utilizing the TOF or 3D camera. FIG. 4A represents an exemplary table having seating for four patrons. In the example shown in FIG. 4A only two patrons are at the table, with one of the patron's plates being full and the other patron's plates being empty. FIG. 4B illustrates how the given table of FIG. 4A can be represented by individual cells 60, which are then utilized to define a table area 62 as well as individual areas 64. As shown in FIG. 4B, the cells 60 are grouped so as to define four individual areas 64, each of which corresponds to one available place setting available at the table. By calculating the average distance of the cells 60 associated with a given individual area 64, and comparing this average distance to the predetermined distance threshold, it is possible to determine whether or not the given patron is done eating. In the example shown in FIG. 4B, a distance valve of 15 or higher indicates that the cell 60 is empty, and a distance valve of lower than 15 indicates that there is a sufficient amount of food left on the plate. As such, individual areas 1, 2 and 4 are considered empty (i.e., meal completed), and individual area 3 is considered full (i.e., meal not completed), which corresponds to the situation shown in FIG. 4A. It is noted that the system can be programmed to send out a notice indicating the meal has been completed when any one of the patrons seated at the table finishes the meal, or after all of the patrons seating at the table complete the meal.

As noted above, the restaurant table management system of the present disclosure provides significant advantages in that, among other things, allows restaurant staff to promptly respond to patron needs and/or preempt patron needs so improve the patron's dining experience; improve supply chain and response; and improve patron turnover. These actions improve the overall guest experience, quality of the restaurant and assist increasing revenue.

The foregoing description has focused on illustrative sequences of steps for performing restaurant table management. The ordering of the steps described above is illustrative, and the order of various steps can be changed without departing from the scope of the disclosure. Moreover, certain steps can be eliminated, and other steps added, without departing from the scope of disclosure.

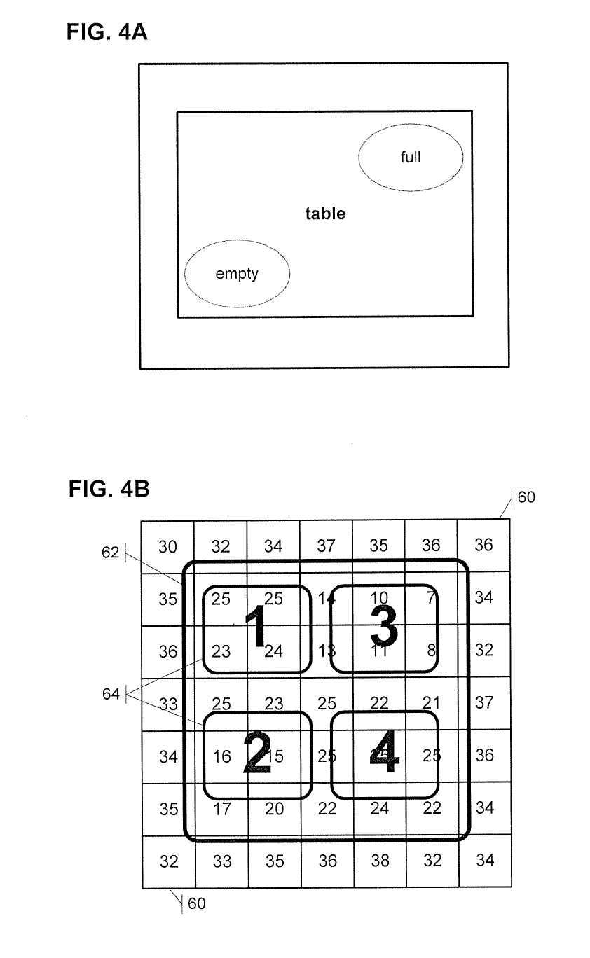

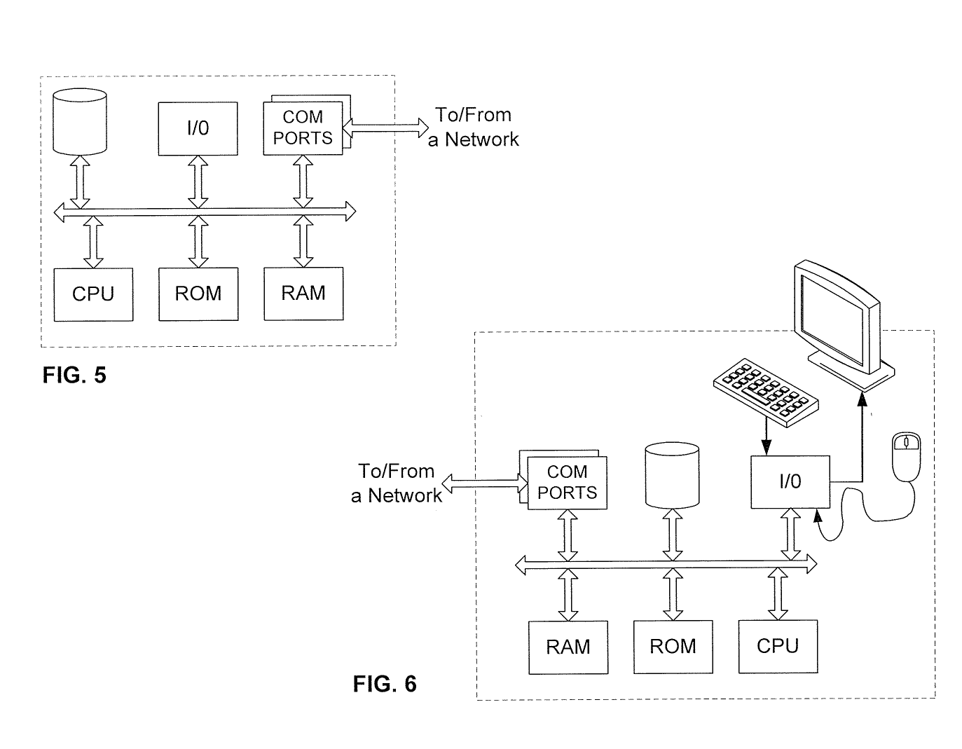

FIGS. 5 and 6 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Unless otherwise stated, all measurements, values, ratings, positions, magnitudes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A restaurant table management system for use in a restaurant, the restaurant table management system comprising:
a processing subsystem including a processor, a memory, an input device and an input/output device, each of which communicates with the other,
an imaging device for recording activity of a patron and contents on a table within the restaurant, the imaging device communicates with the input device of the processing subsystem,
a theme park database storing information regarding past orders and future activities associated with patrons frequenting the restaurant, each of the patrons having a specific identification code for identifying a given patron, and
a user device which receives and transmits information to the processing subsystem,
wherein the user device inputs the identification code associated with a given patron and transmits the identification code to the processing subsystem, and
the processor retrieves the information stored in the theme park database associated with the identification code of the given patron, and predicts service needs of the patron based on the activity of patron and data contained in the theme park database associated with the given patron.

2. The restaurant table management system of claim 1, wherein the processing subsystem outputs the service needs predictions generated by the processor to the user device, the service needs predictions being displayed on the user device in conjunction with the patron identification code and a table number indicating the table within the restaurant that the given patron is seated.

3. The restaurant table management system of claim 1, wherein a record of the given patron is updated in the theme park database each time the given patron places an order, said order being entered into the user device and then wirelessly communicated to the processing subsystem.

4. The restaurant table management system of claim 1, wherein the processing subsystem monitors future scheduled activities of the patron utilizing the data stored in the theme park data for the given patron, and outputs an alert which is transmitted to the user device if the difference between the current time and the scheduled start time for a scheduled future activity of the given patron is less than a defined time.

5. The restaurant table management system of claim 1, wherein the processing subsystem monitors movement of the given patron utilizing images provided by the imaging device, said processing subsystem determining that the given patron has completed the meal by comparing current images received from the imaging device with previous images received from the imaging device and a level of movement between the current images and the previous images are less than a threshold for a defined period of time.

6. The restaurant table management system of claim 1, wherein the processing subsystem monitors a distance between the imaging device and the contents on the table utilizing the imaging device, said processing subsystem determining that the given patron has completed the meal when the distance between the imaging device and the contents on the table is larger than a defined threshold.

7. The restaurant table management system of claim 6, wherein the imaging device is at least one of a 3D camera or a time of flight camera.

8. The restaurant table management system of claim 6, wherein when the processing subsystem determines the meal has been completed, the processing subsystem outputs an alert which is transmitted to the user device.

9. A method for providing restaurant table management for use in a restaurant, the method comprising:
monitoring activity of a patron and contents on a table within the restaurant, and recording images of the activity and storing the images in a memory device, each of the stored images being associated with a given patron, with each patron having a specific identification code for identifying the patron,
generating a theme park database for storing information regarding past orders and future activities associated with patrons frequenting the restaurant, the information for each of the patrons being stored utilizing the identification code associated with a given patron,
correlating data regarding the stored images of a given patron's activity and the information stored in the theme park database associated with the given patron,
predicting the service needs of the given patron based on the correlated data regarding the activity of patron and data contained in the theme park database associated with the given patron, and
outputting at least one of a recommendation, a notification and an alert to a user device based on the predicted service needs of the given patron.

10. The method for providing restaurant table management according to claim 9, wherein the service needs predictions are displayed on the user device in conjunction with the patron identification code and a table number indicating the table within the restaurant that the given patron is seated.

11. The method for providing restaurant table management according to claim 9, further comprising updating a record of the given patron in the theme park database each time the given patron places an order.

12. The method for providing restaurant table management according to claim 9, further comprising monitoring future scheduled activities of the given patron utilizing the data stored in the theme park data for the given patron, and outputting an alert which is transmitted to the user device if the difference between the current time and the scheduled start time for a scheduled future activity of the given patron is less than a defined time.

13. The method for providing restaurant table management according to claim 9, further comprising monitoring movement of the given patron utilizing images provided by the imaging device, and determining that the given patron has completed the meal by comparing current images received from an imaging device with previous images received from the imaging device and a level of movement between the current images and the previous images are less than a threshold for a defined period of time.

14. The method for providing restaurant table management according to claim 9, further comprising monitoring a distance between an imaging device and the contents on the table, and determining that the given patron has completed the meal when the distance between the imaging device and the contents on the table is larger than a defined threshold.

15. The method for providing restaurant table management according to claim 14, wherein the imaging device is at least one of a 3D camera or a time of flight camera.

16. The method for providing restaurant table management according to claim 14, wherein when it is determined that the meal has been completed, an alert is transmitted to the user device.
